(19) United States
(12) Patent Application Publication
(10) Pub. No.: US 2024/0322211 A1
(43) Pub. Date: Sep. 26, 2024

(54) SYSTEM FOR CONDITIONING A PLURALITY OF SUPERIMPOSED SUB-STACKS OF SOLID OXIDE CELLS OF THE HIGH-TEMPERATURE SOEC/SOFC TYPE

(71) Applicant: COMMISSARIAT A L'ENERGIE ATOMIQUE ET AUX ENERGIES ALTERNATIVES, Paris (FR)

(72) Inventor: Nicolas DEVANCIARD, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/186,407

(22) Filed: Mar. 20, 2023

(30) Foreign Application Priority Data
Mar. 22, 2022 (FR) 22 02538

(51) Int. Cl. H01M 8/1213; H01M 8/2432; H01M 8/2475; H01M 8/248

(52) U.S. Cl. CPC H01M 8/1213; H01M 8/2432; H01M 8/2475; H01M 8/248; H01M 2008/1293

(57) ABSTRACT

A system may condition a plurality of sub-stacks of high-temperature SOEC/SOFC-type solid oxide cells forming a modular stack. Such a system may include: a thermal enclosure; a plurality of sub-stacks; a plurality of end plates, each having an upper face and a lower face, the surface of an upper face being of greater dimension than the surface of a lower face of a sub-stack, and the surface of a lower face being of greater dimension than the surface of an upper face of a sub-stack so as to obtain one or more free surfaces which are not superimposed with a sub-stack; a plurality of die-forming supports, including a recess; a plurality of flexible elements above a recess; a plurality of bearing elements capable of coming into contact with a flexible element so as to deform it.

### TECHNICAL FIELD

The present invention relates to the general field of high-temperature electrolysis (HTE), in particular high-temperature steam electrolysis (HTSE), carbon dioxide (CO₂) electrolysis, or even high-temperature co-electrolysis of steam and carbon dioxide (CO₂).

More specifically, the invention relates to the field of high-temperature solid oxide electrolysers, commonly denoted by the acronym SOEC (Solid Oxide Electrolysis Cell).

It also relates to the field of high-temperature solid oxide fuel cells, commonly denoted by the acronym SOFC (Solid Oxide Fuel Cell).

Thus, more generally speaking, the invention relates to the field of stacks of solid oxide cells of the SOEC/SOFC type operating at a high temperature.

More specifically, the invention relates to a system for conditioning a plurality of superimposed sub-stacks of solid oxide cells of the SOEC/SOFC type operating at a high temperature, allowing the sub-stacks to be conditioned simultaneously.

### PRIOR ART

The scope of an SOEC-type high-temperature solid oxide electrolyser involves transforming, by using an electric current, within the same electrochemical device, steam (H₂O) into dihydrogen (H₂) and dioxygen (O₂), and/or transforming carbon dioxide (CO₂) into carbon monoxide (CO) and dioxygen (O₂). Within the scope of an SOFC-type high-temperature solid oxide fuel cell, this operation is reversed to produce an electric current and heat under a supply of dihydrogen (H₂) or other fuels such as methane (CH₄), natural gas, or biogas, and of dioxygen (O₂), generally air. For simplicity purposes, the description provided hereafter prioritises the functioning of an SOEC-type high-temperature solid oxide electrolyser carrying out the electrolysis of steam. However, this functioning is applicable to the electrolysis of carbon dioxide (COA or even to the high-temperature co-electrolysis (HTE) of steam with carbon dioxide (CO₂). Moreover, this functioning is transposable in the case of an SOFC-type high-temperature solid oxide fuel cell.

Water electrolysis is advantageously carried out at a high temperature, typically between 600 and 1,000° C., since it is more advantageous to electrolyse steam than liquid water and since part of the energy required for the reaction can be supplied by heat, which is less expensive than electricity.

For high-temperature electrolysis of steam (HTE or HTSE) to take place, an SOEC-type high-temperature solid oxide electrolyser is formed by a stack of repeat units, each including a solid oxide electrolysis cell, or an electrochemical cell, formed by three anode/electrolyte/cathode layers superimposed on top of one another, and of metal alloy interconnect plates, also called bipolar plates or interconnects. Each electrochemical cell is clamped between two interconnect plates. An SOEC-type high-temperature solid oxide electrolyser is thus an alternating stack of electrochemical cells and interconnects. An SOFC-type high-temperature solid oxide fuel cell is formed by the same type of stack of repeat units. Given that this high-temperature technology is reversible, the same stack can operate in electrolysis mode and produce hydrogen and oxygen from water and electricity, or in fuel cell mode and produce electricity from hydrogen and oxygen.

Each electrochemical cell corresponds to an electrolyte/electrode assembly, which is generally a multi-layer, ceramic assembly, the electrolyte whereof is formed by a central ion conductor layer, this layer being solid, dense and impervious, and clamped between the two porous layers forming the electrodes. It should be noted that additional layers can exist, the purpose whereof however is only to improve one or more of the layers described hereinabove.

The electric and fluid interconnect devices are electron conductors which, from an electrical perspective, provide the connection of each repeat electrochemical cell in the stack of repeat units, guaranteeing the electrical contact between one face and the cathode of a cell and between the other face and the anode of the next cell, and from a fluid perspective, guaranteeing the supply of reagents and the discharge of products for each of the cells. The interconnects thus carry out the functions of supplying and acquiring electric current and of delimiting the compartments for the circulation of gases, for distribution and/or acquisition.

More specifically, the main purpose of the interconnects is to ensure the passage of the electric current, as well as the circulation of the gases in the vicinity of each cell (i.e.: injected steam, extracted hydrogen and oxygen for HTE; air and fuel including the injected hydrogen and extracted steam for an SOFC), and to separate the anode and cathode compartments of two adjacent cells, which are the gas circulation compartments respectively situated on the anode side and on the cathode side of the cells.

In particular, for an SOEC-type high-temperature solid oxide electrolyser, the cathode compartment contains the steam and hydrogen produced by the electrochemical reaction, whereas the anode compartment contains a draining gas, if present, and oxygen, the other product of the electrochemical reaction. For an SOFC-type high-temperature solid oxide fuel cell, the anode compartment contains the fuel, whereas the cathode compartment contains the oxidant.

For carrying out high-temperature electrolysis (HTE) of steam, steam (H₂O) is injected into the cathode compartment. Under the action of the electric current applied to the cell, dissociation of the water molecules in the form of steam takes place at the interface between the hydrogen electrode (cathode) and the electrolyte: this dissociation produces dihydrogen gas (H₂) and oxygen ions (O²⁻). The dihydrogen (H₂) is collected and discharged at the outlet of the hydrogen compartment. The oxygen ions (O²⁻) migrate through the electrolyte and recombine into dioxygen (O₂) at the interface between the electrolyte and the oxygen electrode (anode). A draining gas, such as air, can circulate at the anode and thus collect the oxygen generated in gaseous form at the anode.

In order to ensure the operation of a solid oxide fuel cell (SOFC), air (oxygen) is injected into the cathode compartment of the fuel cell and hydrogen is injected into the anode compartment. The oxygen in the air will dissociate into O²⁻ ions. These ions will migrate in the electrolyte from the cathode to the anode in order to oxidise the hydrogen and form water while simultaneously producing electricity. With SOFC, as with SOEC electrolysis, the steam is situated in the dihydrogen (H₂) compartment. Only the polarity is reversed.

By way of illustration, FIG. 1 shows a diagrammatic view of the operating principle of an SOEC-type high-temperature solid oxide electrolyser. The purpose of such an electrolyser is to transform steam into hydrogen and oxygen according to the following electrochemical reaction:

2H₂O→2H₂+O₂.

This reaction takes place electrochemically in the cells of the electrolyser. As shown diagrammatically in FIG. 1, each unit electrolysis cell 1 is formed by a cathode 2 and an anode 4, placed on either side of a solid electrolyte 3. The two electrodes (cathode and anode) 2 and 4 are electron and/or ion conductors, made of porous material, and the electrolyte 3 is gas-tight, an electron insulator and an ion conductor. The electrolyte 3 can in particular be an anion conductor, more precisely an anion conductor of the O²⁻ ions and the electrolyser is thus referred to as an anion electrolyser, as opposed to proton electrolytes (H⁺).

The electrochemical reactions take place at the interface between each of the electron conductors and the ion conductor.

At the cathode 2, the half-reaction is as follows:

2H₂O+4e⁻→2H₂+2O²⁻.

At the anode 4, the half-reaction is as follows:

2O²⁻→O₂+4e⁻.

The electrolyte 3 inserted between the two electrodes 2 and 4 is the site of migration of the O²⁻ ions under the effect of the electrical field created by the difference in potential imposed between the anode 4 and the cathode 2.

As shown in brackets in FIG. 1, the steam at the cathode inlet can be accompanied by hydrogen H₂ and the hydrogen produced and recovered at the outlet can be accompanied by steam. Similarly, as shown by dotted lines, a draining gas, such as air, can additionally be injected at the inlet on the anode side in order to remove the oxygen produced. The injection of a draining gas plays the additional role of acting as thermal regulator.

A unit electrolyser, or electrolysis reactor, consists of a unit cell as described hereinabove, with a cathode 2, an electrolyte 3 and an anode 4, and of two interconnects which perform the electrical and fluid distribution functions.

In order to increase the flow rates of hydrogen and oxygen produced, it is known to stack several unit electrolysis cells on top of one another, separating them with interconnects. The assembly is positioned between two end interconnect plates, which bear the power supplies and the gas supplies of the electrolyser (electrolysis reactor).

An SOEC-type high-temperature solid oxide electrolyser thus comprises at least one, generally a plurality of electrolysis cells stacked on top of one another, each unit cell being formed by an electrolyte, a cathode and an anode, the electrolyte being inserted between the anode and the cathode.

As stated above, the fluid and electrical interconnect devices, which are in electrical contact with one or more electrodes generally perform the functions of supplying and acquiring electrical current and delimit one or more compartments for the circulation of the gases.

Thus, the purpose of the so-called cathode compartment is to distribute the electric current and steam and also to recover the hydrogen at the cathode in contact therewith.

The purpose of the so-called anode compartment is to distribute the electric current and also to recover the oxygen produced at the anode in contact therewith, optionally with the use of a draining gas.

FIG. 2 shows an exploded view of repeat units of an SOEC-type high-temperature solid oxide electrolyser of the prior art. This electrolyser includes a plurality of unit electrolysis cells C1, C2, of the solid oxide cell (SOEC) type, stacked alternately with interconnects 5. Each cell C1, C2 consists of a cathode 2.1, 2.2 and an anode (only the anode 4.2 of the cell C2 is shown), between which an electrolyte (only the electrolyte 3.2 of the cell C2 is shown) is arranged.

The interconnect 5 is a component made of metal alloy, which provides the separation between the cathode compartment 50 and the anode compartment 51, defined by the volumes that lie between the interconnect 5 and the adjacent cathode 2.1 and between the interconnect 5 and the adjacent anode 4.2 respectively. It also provides for distribution of the gases to the cells. The injection of steam into each repeat unit takes place in the cathode compartment 50. The collection of the hydrogen produced and of the residual steam at the cathode 2.1, 2.2, takes place in the cathode compartment 50 downstream of the cell C1, C2 after dissociation of the steam thereby. The collection of the oxygen produced at the anode 4.2 takes place in the anode compartment 51 downstream of the cell C1, C2 after dissociation of the steam thereby. The interconnect 5 ensures passage of the current between the cells C1 and C2 by direct contact with the adjacent electrodes, i.e. between the anode 4.2 and the cathode 2.1.

Since the operating conditions of a high-temperature solid oxide electrolyser (SOEC) are very similar to those of a solid oxide fuel cell (SOFC), the same technological restrictions apply.

Thus, the correct operation of such stacks of SOEC/SOFC-type solid oxide cells operating at a high temperature mainly requires the following points to be met.

Firstly, electrical insulation must be present between two successive interconnects, without which the electrochemical cell will be short-circuited, and a good electrical contact and a sufficient contact surface must also be present between a cell and an interconnect. The lowest ohmic resistance possible is sought between cells and interconnects.

Moreover, a seal must be obtained between the anode and cathode compartments, without which the gases produced will recombine, resulting in a reduced yield and above all in the appearance of hot spots, which damage the stack.

Finally, a good distribution of the gases is required, both at the inlet and on collection of the gases produced, without which distribution there will be a loss of yield, non-uniformity of pressure and non-uniformity of temperature within the different repeat units, or even unacceptable deterioration of the electrochemical cells.

The gases entering and leaving a high-temperature electrolysis (SOEC) or fuel cell (SOFC) stack operating at a high temperature can be managed using devices such as that shown with reference to FIG. 3. The device 13 thus includes cold parts PF and hot parts PC, the latter comprising the furnace hearth 11, the furnace bell 10, a looped pipe 12 for managing the gas inlets and outlets and the high-temperature electrolysis (SOEC) or fuel cell (SOFC) stack 20.

Furthermore, FIG. 4 shows an example of an assembly 80 comprising such a stack 20 and a clamping system 60 thereof. Such an assembly 80 can be as described in the French patent application No. 3 045 215 A1.

Thus, the stack 20 includes a plurality of electrochemical cells 41 each formed of a cathode, an anode and an electrolyte inserted between the cathode and the anode, and a plurality of intermediate interconnects 42, each arranged between two adjacent electrochemical cells 41. Moreover, it includes an upper end plate 43 and a lower end plate 44, also referred to as the upper stack end plate 43 and the lower stack end plate 44 respectively, between which the plurality of electrochemical cells 41 and the plurality of intermediate interconnects 42 are clamped, i.e. between which the stack is located.

The clamping system 60 includes an upper clamping plate 45 and a lower clamping plate 46, between which the stack 20 is clamped. Each clamping plate 45, 46 includes four clamping holes 54 through which clamping rods 55, or tie rods, extend. Clamping means 56, 57, 58 are provided at the ends thereof.

In general, the stacks 20 to date have a limited number of electrochemical cells 41. Typically, the Applicant implements stacks 20 of 25 electrochemical cells 41 with 100 cm² of active area. The conditioning step is carried out in a unitary way, with each stack being placed alone in a conditioning bench. The cycle applied allows both the sealing step and the reduction step for the electrochemical cells 41 to be carried out. The cycle ends with various electrochemical measurements to characterise the performance of the stack, before it is delivered for use.

Prior to operation, the stack 20 must be subjected to at least one so-called reduction heat treatment step in order to give the electrochemical cells 41 their reduced form, and not their oxidised form which they initially take. This reduction step can be a thermomechanical cycle under reducing gas for the hydrogen electrode and air or a neutral gas for the oxygen electrode. Such a heat treatment step has, for example, been described in the European patent application No. 2 870 650 A1.

Furthermore, the stacks 20 implemented to date typically use seals, at each of their stages, which seals must guarantee the tightness between two adjacent and separate gas circulation compartments, i.e. an anode compartment and a cathode compartment. Such seals have been described in the European patent application No. 3 078 071 A1. These seals have the particularity of requiring thermal conditioning during which they are crushed.

Moreover, the contact elements, such as the layers described in the European patent application No. 2 900 846 A1 or the Nickel grates, are also crushed during thermal conditioning and during operation of the stack 20, which ensures that they are correctly positioned. The elements that act as contact elements in the hydrogen chamber are also crushed.

In other words, during the thermal conditioning step, a stack 20 is crushed several centimetres. To date, given the relatively small number of cells stacked, crushing takes place correctly.

However, the Applicant has envisaged stack designs with a greater number of electrochemical cells, typically in excess of 25 cells. In such a case, the expected displacement when clamping the stack can lead to mechanical problems such as blockages by jamming on the guide rods. These blockages prevent proper thermal conditioning, and consequently normal operation of the stack.

One solution to these drawbacks is to provide a stacking concept wherein several sub-stacks are assembled, by means of stiffening plates, in order to manage significant crushing. However, each sub-stack must be conditioned separately and thus a large number of stacks and sub-stacks must be produced.

However, conditioning such a stack is time-consuming and costly because heating requires energy. Moreover, current devices allow only one stack or sub-stack to be conditioned at a time.

As a result, there remains a need to improve the conditioning principle for high temperature electrolysis (SOEC) or fuel cell (SOFC) stacks, in particular to condition a plurality of sub-stacks at the same time.

### DESCRIPTION OF THE INVENTION

The purpose of the invention is to at least partially satisfy the aforementioned needs and overcome the drawbacks regarding the productions of the prior art.

The invention, according to one of the aspects thereof, thus relates to a system for conditioning a plurality of sub-stacks of SOEC/SOFC-type solid oxide cells operating at a high temperature, jointly forming a modular stack of high-temperature SOEC/SOFC-type solid oxide cells,

each sub-stack including a plurality of electrochemical cells each formed of a cathode, an anode and an electrolyte inserted between the cathode and the anode, and a plurality of intermediate interconnects, each arranged between two adjacent electrochemical cells, characterised in that the system includes:
a thermal enclosure delimiting an internal volume,
a plurality of sub-stacks placed in the internal volume, at least two sub-stacks being at least partially superimposed on one another, each sub-stack having an upper face and a lower face,
a plurality of end plates, each sub-stack being arranged between an upper end plate and a lower end plate, each end plate having an upper face and a lower face, at least one of which is in contact with at least one sub-stack, the surface of an upper face of an end plate being of greater dimension than the surface of a lower face of a sub-stack, and the surface of a lower face of an end plate being of greater dimension than the surface of an upper face of a sub-stack such that each upper face and each lower face of an end plate in contact with at least one sub-stack has one or more free surfaces which are not superimposed with a sub-stack and which are not in contact with a sub-stack,
a plurality of die-forming supports arranged on the one or more free surfaces of the upper faces of the end plates in contact with at least one sub-stack, each die-forming support including a recess opening out onto an upper face of the die-forming support opposite a free surface,
a plurality of flexible elements, each of which is arranged above a recess bearing on the die-forming support, on either side of the recess, and in particular positioned on a counterbore,
a plurality of bearing elements, arranged beneath the one or more free surfaces of the lower faces of the end plates in contact with at least one sub-stack, each bearing element being capable of coming into contact with at least one flexible element when conditioning the sub-stacks and of deforming it by penetration of at least one recess.

The conditioning system according to the invention can further include one or more of the following features, which must be considered singly or according to any technical combinations possible.

The recesses can have a V-shaped cross-section. The recesses can be formed by counterboring the die-forming supports.

The flexible elements can take the form of flexible strips.

The one or more flexible elements associated with the same first sub-stack can have a different thickness to the thickness of the one or more flexible elements associated with the same second sub-stack superimposed on the first sub-stack.

In particular, the thickness of the flexible elements can be increasing from the top of the modular stack to the bottom of the modular stack.

Moreover, the flexible elements and/or the die-forming supports and/or the bearing elements can be made of metal, in particular Inconel®, or ceramic.

Furthermore, there is no design limit to the number of sub-stacks that can be superimposed. However, in order to take into account the acceptable height of the conditioning bench, the number of sub-stacks can preferably be between 2 and 20.

The modular stack can be arranged between an upper main load distribution plate and a lower base plate.

Moreover, the thermal enclosure can consist of a furnace hearth, forming the lower horizontal wall of the thermal enclosure, an upper horizontal wall and side walls, together defining the internal volume.

The system can further include a force rod for applying a compressive force to the modular stack, in particular to an upper main load distribution plate.

Moreover, according to another of its aspects, the invention further relates to a method for clamping a plurality of sub-stacks of solid oxide cells of the SOEC/SOFC type operating at a high temperature, forming a modular stack by means of a conditioning system as defined hereinabove, characterised in that it includes the step of exerting a vertical compression force on the sub-stacks with a force uptake through the flexible elements bearing on the supports.

The method can advantageously be implemented under a neutral gas, directly inside the sub-stacks or via the thermal enclosure, which is rendered totally inert.

### BRIEF DESCRIPTION OF THE DRAWINGS

The invention will be better understood upon reading the following detailed description of non-limiting example implementations thereof and upon examining the diagrammatic and partial figures of the accompanying drawing, for which:

FIG. 1 is a diagrammatic view showing the operating principle of a high-temperature solid oxide electrolyser (SOEC),

FIG. 2 shows an exploded diagrammatic view of a part of a high-temperature solid oxide electrolyser (SOEC) comprising interconnects and cells according to the prior art,

FIG. 3 shows the architectural principle of a device on which a high-temperature electrolysis (SOEC) or fuel cell (SOFC) stack operating at a high temperature is placed,

FIG. 4 shows a perspective, top view of one example of a stack of SOEC/SOFC-type solid oxide cells according to the prior art with a stack clamping system,

FIG. 5 diagrammatically shows a partial sectional view of one example of a conditioning system in accordance with the invention for a plurality of sub-stacks of SOEC/SOFC-type solid oxide cells operating at a high temperature before the stack has been conditioned by V-bending metal strips, and

FIG. 6 diagrammatically shows a partial sectional view of the example of the conditioning system in accordance with the invention in FIG. 5 after the stack has been conditioned by V-bending the metal strips.

In all of these figures, identical references can designate identical or similar elements.

Moreover, the different parts shown in the figures are not necessarily displayed according to a uniform scale in order to make the figures easier to read.

### DETAILED DESCRIPTION OF THE INVENTION

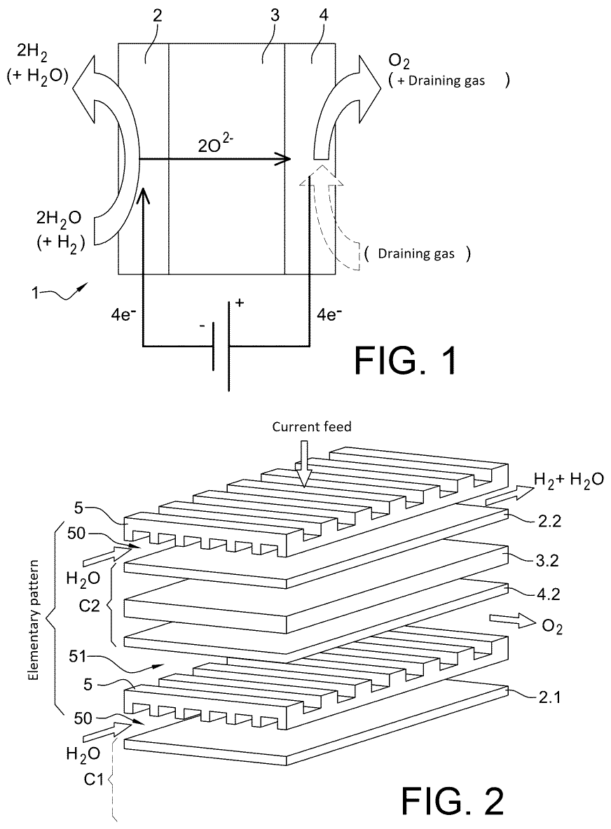

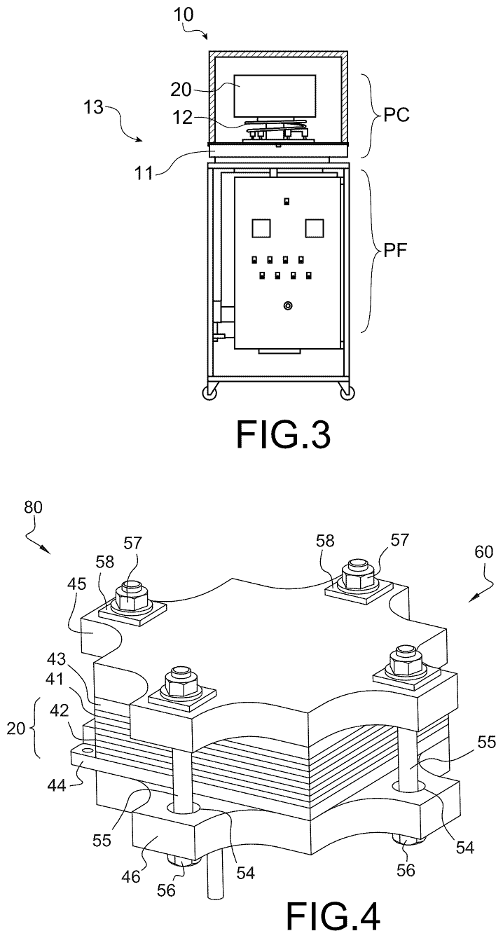

FIG. 1 to 4 have been described hereinabove in the paragraphs on the prior art and technical background of the invention. It is specified here that, in FIGS. 1 and 2, the symbols and arrows showing the supply of steam H₂O, the distribution and collection of dihydrogen H₂, oxygen O₂, air, and the electric current, are shown for the purposes of clarity and precision, to illustrate the operation of the devices shown.

It should also be noted that all component parts (anode/electrolyte/cathode) of a given electrochemical cell are preferentially ceramics. The operating temperature of a high-temperature SOEC/SOFC-type stack typically lies in the range 600 to 1,000° C.

Moreover, the terms “upper” and “lower” must be understood herein to be relative to the normal orientation of a sub-stack or stack of the SOEC/SOFC type when in the configuration of use thereof.

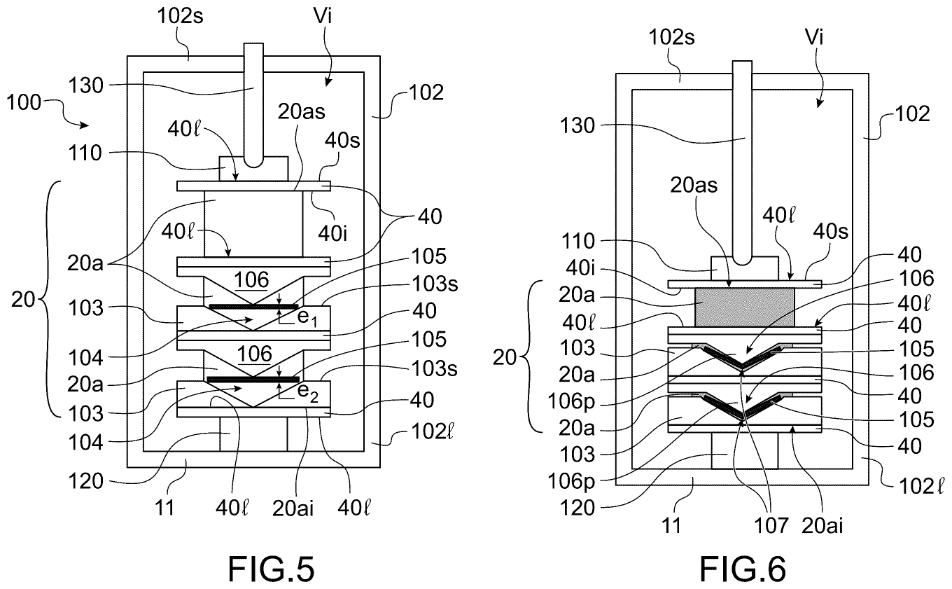

One example of a conditioning system 100 in accordance with the invention for a plurality of SOEC/SOFC-type sub-stacks 20a to form a modular stack 20 will now be described with reference to FIGS. 5 and 6.

The conditioning of three sub-stacks 20a is considered in general here. However, the number of sub-stacks 20a is not limited by design, but rather by having to take into account the acceptable height of the conditioning bench. The number of sub-stacks 20a is thus preferably between 2 and 20.

As described hereinabove in the section on the prior art and technical background of the invention, each sub-stack 20a includes a plurality of electrochemical cells 41 each formed by a cathode, an anode and an electrolyte inserted between the cathode and the anode, and a plurality of intermediate interconnects 42, each arranged between two adjacent electrochemical cells 41.

The three sub-stacks 20a are placed in the internal volume Vi of a thermal enclosure 102 of the conditioning system 100. This thermal enclosure 102 is, in this case, constituted by a furnace hearth 11, as described hereinabove, which forms the lower horizontal wall of the thermal enclosure 102, and by an upper horizontal wall 102s and side walls 102l, together defining the internal volume Vi, as visible in FIGS. 5 and 6.

Thus, the three sub-stacks 20a are placed in the internal volume Vi of the thermal enclosure 102 while being completely superimposed on one another.

Each of the sub-stacks 20a has an upper face 20as and a lower face 20ai, in this case with identical surface areas.

Moreover, the system 100 includes four end plates 40, inserted with the sub-stacks 20a. More specifically, each sub-stack 20a is arranged between an upper end plate 40 and a lower end plate 40, whereby the same end plate 40 can thus act both as the upper end plate for one sub-stack 20a and as the lower end plate for another sub-stack 20a.

Each end plate 40 has an upper face 40s and a lower face 40i, in this case of identical surface areas, and at least one of which is in contact with a sub-stack 20a.

Moreover, the modular stack 20 thus obtained is arranged between an upper main load distribution plate 110 and a lower stack base plate 120. The lower stack base plate 120 is arranged on the furnace hearth 11.

Moreover, the system 100 includes a force rod 130, with a rounded shape, for applying a compressive force to the modular stack 20, in particular to the upper main load distribution plate 110. In particular, the force rod 130 provides a patellar support on the main load distribution plate 110.

In accordance with the invention, the conditioning of the modular stack 20 by assembling a plurality of sub-stacks 20a on top of one another is carried out in such a way as to minimise the floor space occupied by the conditioning bench, while allowing controlled mechanical clamping to be carried out independently for each sub-stack 20a.

The main mechanical load is thus distributed between the different sub-stacks 20a during crushing when the stack 20 is being conditioned so as to allow force uptake.

Specifically, the main mechanical compression provided by the force rod 130 is distributed between the sub-stacks 20a by dedicated flexible elements 105 in the form of metal strips, which can have different thicknesses e1, e2.

Thus, advantageously, the surface area of an upper face 40s of an end plate 40 is larger than the surface area of a lower face 20ai of a sub-stack 20a. Similarly, the surface area of a lower face 40i of an end plate 40 is larger than the surface area of an upper face 20as of a sub-stack 20a.

In this way, each upper face 40s and each lower face 40i of an end plate 40 in contact with at least one sub-stack 20a has one or more free surfaces 40l that are not superimposed on a sub-stack 20a and that are not in contact with a sub-stack 20a. These free surfaces 40l are shown in FIGS. 5 and 6. They thus correspond to the laterally projecting parts of a sub-stack 20a on all four sides thereof formed on the end plates 40.

Die-forming supports 103 are thus arranged on these free surfaces 40l. It should be noted that, in this example, two long supports 103 can be provided per stage of sub-stack 20a, i.e. one in front of and one behind the sub-stack 20a. In other examples not shown, four supports 103 can be provided per stage of sub-stack 20a, i.e. for example on each side of the sub-stack 20a. The supports 103 can be slightly smaller in height than the stack after conditioning. The supports 103 are advantageously metallic, and are for example made of Inconel®.

As shown in FIG. 5, each die-forming support 103 further includes a recess 104 opening out onto the upper face 103s of the support 103 which is opposite the free surface 401. Each recess 104 has a V-shaped cross-section.

Also advantageously, a plurality of flexible elements 105, in this case in the form of metal strips 105, is arranged above the recesses 104, bearing on the die-forming supports 103 at the counterbores 108 provided for this purpose, on either side of the recesses 104. Each metal strip 105 is, for example, also made of Inconel®. Each metal strip 105 has, for example, a length of about 200 mm and a width of about 10 mm.

The metal strips 105 advantageously have thicknesses e1, e2, as shown in FIG. 5, which are differentiated for each stage. In particular, the metal strips 105 have a thickness which, as in this example, increases from the top of the modular stack 20 to the bottom of the modular stack 20.

Furthermore, a plurality of bearing elements 106 is arranged under the free surfaces 40l of the lower faces 40i of the end plates 40 in contact with a sub-stack 20a. Each bearing element 106 comes into contact with a metal strip 105 by its end forming a punch 106p during the conditioning of the sub-stacks 20a. This contact thus allows the metal strips 105 to be deformed, which bend into a “V” shape so as to penetrate the recesses 104.

Thus, as shown in FIG. 6, non-contacting spaces 107 are obtained between the metal strips 105 and the die-forming supports 103.

In other words, when conditioning a modular stack 20, the free surfaces 40l are advantageously used to insert therein an assembly formed by a die-forming support 103 with a recess 104, a metal strip 105 and a bearing element 106 comprising an end forming a punch 106p so as to offset the mechanical force generated by the weight to which each of the sub-stacks 20a is subjected.

In practice, this force is partially but not totally offset by the force required to V-bend the metal strips 105.

Thus, without modifying the conditioning bench, the system 100 allows the mechanical load to be distributed evenly between the sub-stacks 20a making up the overall modular stack 20 when it is crushed and in operation.

The assembly comprising the support 103, the flexible element 105 and the bearing element 106 is advantageously made of an alloy that is resistant to high temperatures, in particular up to 900° C., and thus preferably chosen to be of the Inconel® type. This assembly is advantageously dimensioned such that after the stack has been crushed, it is not in contact over the entire surface so as not to limit the crushing distance of the stack and thus ensure a good seal between the cells and the sealing of the stack.

Advantageously, the thickness e1, e2 of a metal strip 105 is obtained by means of the V-bending force equation (cold forming force calculation), i.e.:

F=CRLe²/V,
where:
F (expressed in N) is the bending force (in this case 75 N for the middle stage or 150 N for the lower stage so as to offset the weight to which it is subjected, but without exceeding this);
R (expressed in MPa) is the tensile strength of the metal (about 1,000 MPa maximum for Inconel®);
L (expressed in mm) is the bent length (in this case 10 mm);
e (expressed in mm) is the thickness of the metal strip;
V (expressed in mm) is the difference in height before and after crushing the sub-stacks+1 mm (i.e. about 100 mm);
C is the coefficient equal to 1.16 (value used when V>30*e).

As a result, the two metal strips 105 (front and rear) of the middle stage have an approximate thickness e1 of 0.8 mm and the two metal strips 105 (front and rear) of the bottom stage have an approximate thickness e2 of 1.14 mm.

The ends of the metal strips 105 are positioned horizontally and in a repeatable manner on the die-forming supports 103 thanks to the recesses 108 formed by counterbores on the oblique planes of the supports 103.

Once the assembly of the stack in the conditioning bench is complete and as soon as it is mechanically pressed by the force rod 130, the punches 106p are brought to bear against the metal strips 105 thanks to screws positioned in the middle of the sides of the stack between the punch 106p and the upper end plate 40. Two guide rods installed on either side of the screws can allow the upper base of the punch 106p to be held parallel to the upper end plate 40. An identical clamping force can be guaranteed for each screw on the strips 105 by using a torque wrench.

It should be noted that in the configuration shown in FIG. 6, after crushing, the total height of the stack is reduced by about 40% as a result of the forming of the seals present between each cell and with the folded strips 105 in partial contact with the die-forming supports 103 so as not to prevent the stack from being crushed. The force rod 130 will have applied a constant force throughout the stack crushing process during the heating of the furnace.

It goes without saying that the invention is not limited to the aforementioned example embodiment. Various modifications can be made thereto by a person skilled in the art.

1. A system configured for conditioning a plurality of sub-stacks of SOEC/SOFC-type solid oxide cells operating at a high temperature, jointly forming a modular stack of high-temperature SOEC/SOFC-type solid oxide cells, each sub-stack including a plurality of electrochemical cells, the electrochemical cells including a cathode, an anode, and an electrolyte inserted between the cathode and the anode, and a plurality of intermediate interconnects, the intermediate interconnects being arranged between two adjacent electrochemical cells, the system comprising:
a thermal enclosure delimiting an internal volume;
a plurality of sub-stacks placed in the internal volume, at least two of the sub-stacks being at least partially superimposed on one another, each of the sub-stacks having an upper face and a lower face;
a plurality of end plates, each of the sub-stacks being arranged between an upper end plate and a lower end plate, each of the end plates having an upper face and a lower face, at least one of the upper and the lower face being in contact with at least one of the sub-stacks, an upper face surface of an end plate being of greater dimension than a lower face surface of a sub-stack, and a lower face surface of an end plate being of greater dimension than an upper face surface of a sub-stack such that each upper face and each lower face of an end plate in contact with at least one of the sub-stacks has one or more free surfaces which are not superimposed with a non-superimposing sub-stack and which are not in contact with a non-contacting sub-stack;
a plurality of die-forming supports arranged on the one or more free surfaces of the upper faces of the end plates in contact with at least one of the sub-stacks, each die-forming support comprising a recess opening out onto die-forming support upper face opposite a free surface;
a plurality of flexible elements, each of the flexible elements being arranged above a respective recess bearing on the die-forming support, on either side of the respective recess;
a plurality of bearing elements arranged beneath the one or more free surfaces of the lower faces of the end plates in contact with at least one of the sub-stacks, each of the bearing elements being capable of coming into contact with at least one flexible element when conditioning the sub-stacks and of deforming it by penetration of at least one recess.

2. The system of claim 1, wherein the recesses have a V-shaped cross-section.

3. The system of claim 1, wherein the flexible elements take the form of flexible strips.

4. The system of claim 1, wherein the one or more flexible elements associated with a first sub-stack have a first sub-stack thickness different from a second sub-stack thickness of the one or more flexible elements associated with a second sub-stack superimposed on the first sub-stack.

5. The system of claim 4, wherein the first and second sub-stack thickness of the flexible elements increases from a top of the modular stack to a bottom of the modular stack.

6. The system of claim 1, wherein the flexible elements and/or the die-forming supports and/or the bearing elements are made of metal or ceramic.

7. The system of claim 1, wherein a number of sub-stacks is in a range of from 2 to 20.

8. The system of claim 1, wherein the modular stack is arranged between an upper main load distribution plate and a lower base plate.

9. The system of claim 1, wherein the thermal enclosure consists of a furnace hearth, forming a lower horizontal wall of the thermal enclosure, an upper horizontal wall, and side walls, together defining the internal volume.

10. The system of claim 9, further comprising:
a force rod configured for applying a compressive force to the modular stack.

11. A method for clamping a plurality of sub-stacks of solid SOEC/SOFC-type oxide cells operating at a high temperature, forming a modular stack using the conditioning system of claim 1, the method comprising:
exerting a vertical compression force on the sub-stacks with a force uptake through the flexible elements bearing on the die-forming supports.

12. The system of claim 1, wherein each of the flexible elements is positioned on a counterbore.

13. The system of claim 1, wherein the recesses have a V-shaped cross-section and are formed by counterboring the die-forming supports.

14. The system of claim 1, wherein the thermal enclosure comprises a furnace hearth, forming a lower horizontal wall of the thermal enclosure, an upper horizontal wall, and side walls, together defining the internal volume.

15. The system of claim 9, further comprising:
a force rod configured for applying a compressive force to an upper main load distribution plate of the modular stack.
